(19) United States
(12) Patent Application Publication
(10) Pub. No.: US 2017/0147793 A1
(43) Pub. Date: May 25, 2017

(54) SYSTEM FOR REMOTE MONITORING AND SUPERVISION OF DATA

(71) Applicant: PROMEDITEC S.R.L., Trieste (IT)

(72) Inventor: Luca EMILI, Milano (IT)

(21) Appl. No.: 15/322,094

(22) PCT Filed: Jun. 26, 2015
(86) PCT No.: PCT/EP2015/064528

§ 371 Date: Dec. 23, 2016

(30) Foreign Application Priority Data
Jun. 27, 2014 (IT) MI2014A001169

(51) Int. Cl. G06F 19/00; H04N 7/14; G06F 21/62

(52) U.S. Cl. CPC G06F 19/363; G06F 21/6218; H04N 7/147

(57) ABSTRACT

A system for remote monitoring and supervision of data, particularly for activities associated with clinical trials, which comprises: a first station, which pertains to an area in which the data are stored, the station being provided with first processing elements and elements for acquiring an item of information associated with the monitored data; a second station, provided with second processing elements and located in a remote area with respect to the area of the first station and connected to the first station by way of a telecommunications network; wherein the system has the peculiarity that the second processing elements are configured to display the information acquired at the first station and to prevent the saving of this information on non-volatile memory devices and to optionally save restore information in an encrypted manner.

The present invention relates to a system and a method for the remote monitoring and supervision of data, particularly for activities associated with clinical trials.

The term “clinical trial” is used to mean a type of research carried out in particular in order to collect data on the safety and efficacy of new medicines or new devices used in the health/medical sector. Typically, the carrying out of the clinical trial must meet stringent legal and ethical requirements which require for example the gathering of sufficient information about the pre-clinical safety of the medicines and devices to be tested on patients, the verification of data in the medical files of the patients, the obtaining of authorizations by an ethics committee tasked with vetting the medical staff who carry out the trial or collect the “informed consent” documents necessary for participation, by the patients, in the trial. The clinical trial involves, among other things, the exchange of information between two parties: the administrator of the clinical data, who works at a center (Central Clinical Study File/Investigator Site, for example a hospital where the patients taking part in the clinical trial are being treated), and the clinical researcher (also known as Clinical Research Associate, abbreviated to CRA, or Trial/Clinical Monitor), whose duties are known to the person skilled in the art.

Briefly, the administrator of the clinical data collects, at the data collection center (referred to simply as “data center”), such as a hospital research center involved in the clinical trial, the data obtained from the clinical trial, which consist of various types of documents, mainly on paper. The administrator of the clinical data verifies the consistency and completeness of the data, organizes it consistently according to criteria that make it amenable to consultation, places it in secure files and permits it to be seen only by authorized persons, such as the clinical researcher. Since the data collected are personal information and information relating to the state of health of the patients involved in the trial (i.e. sensitive data), the handling of such data requires not only that the patients sign an “informed consent” document but also that rigorous procedures be put in place, for which the administrator of the data is partially responsible, for protecting these data in order to safeguard the confidentiality of the patients. The administrator of the clinical data can be a doctor assigned by the hospital participating in the clinical trial, who, in addition to verifying the consistency of the medical files of the patients, compiles a document known as a Case Report Form, abbreviated to CRF, which contains summary data obtained during the trial. The CRF, which can be both on paper and in electronic form, is compiled, on paper and/or electronically for example by accessing a remote portal, by the doctor who assumes responsibility for the content and it is signed by that doctor.

For their part, the clinical researcher is tasked with supervising and verifying the quality and quantity of the data acquired during the trial and kept by the data administrator. The verifications take place with varying levels of intensity and frequency, which both depend on the type of trial but also on the budget made available to finance the clinical researcher. Typically, the clinical researcher is usually sent by the sponsor of the clinical trial with the task of verification of the source data, and in particular verification of the consistency and the correspondence of the data contained in the medical files with the content of the CRF signed by the doctor. Furthermore the researcher has the task of verifying that all the data necessary to the trial are present.

Owing to legal restrictions that require that the original documents be consulted without it being possible to remove these from the data collection center, the researcher has no choice but to personally visit the data collection center. This operation is very inconvenient and expensive. In fact once the researcher has arrived at the data collection center, and that is to say after having sustained the costs of the trip, he/she has to provide his/her credentials, ask to access the protected area where the data are kept, and verify the required data in an unfamiliar environment with evident inconvenience and costs. The traditional way in which the supervision activity is carried out by the researcher is not therefore devoid of drawbacks.

A first drawback is represented by the fact that the costs of the trip of the researcher, which often involves international transfers, are high.

Another drawback is represented by the time and consequent inconvenience of the researcher in order to reach the center where the data are kept.

Another drawback is represented by the fact that if the data made available by the data collection center are partial or require a supplementary investigation by the researcher which is to be conducted at another time, the researcher has no choice but to interrupt the consultation and, possibly, visit the data center once again, sustaining the costs of a new trip.

Another drawback, which is partly a consequence of the previous one, is due to the fact that if the supervision activity of the researcher who is visiting the center is interrupted, the documents viewed must be immediately refiled and securely stored by the data administrator. As a consequence, once the consultation has resumed, the researcher is required to remember which documents he/she had requested, at what point the consultation had reached, and has to ask the administrator again for the documents for consultation. Such problem also arises if the researcher is substituted with another, to whom the previous researcher has not provided sufficient information for the handover and who is thus in the inconvenient position of having to reconstruct the history of the consultation activity or even having to consult anew documents that had already been consulted previously.

Solutions based on sending, for example by way of email, copies of the original documents to the researcher by the data administrator are not feasible: not only would this render the supervision invalid as it must be based only on original documents and not on copies thereof, but it is also prohibited by law because it would expose the patients taking part in the trial to risks to their confidentiality if the copies are lost. It is even less feasible to move the original documents from the data collection center, owing to legal restrictions or obligations which are present for example in the informed consent document in which the patients are guaranteed wide-ranging protection of their confidentiality.

In the state of the art there is no system for the supervision of data for clinical trials which, on the one hand, complies with the regulations in force that require the consultation of the original documents without their being moved from the place where they are located and, on the other hand, reduces the drawbacks owing to the transfers of the supervisor.

The aim of the present invention is to overcome the above mentioned drawbacks of the known art, by providing a new system that is capable of enabling the remote supervision of data for clinical trials and at the same time of guaranteeing the protection of these data from unauthorized consultation or from loss.

Within this aim, an object of the present invention is to provide a system that offers a work environment which is adapted to the carrying out of the supervision and monitoring activity, which can be easily implemented and which does not require significant reconfigurations of existing systems.

A further object of the invention is to improve the method of data consultation which is secure and which complies with the regulations in force.

This aim and these and other objects which will become better apparent hereinafter are achieved by a system according to claim 1 and by a method according to claim 10.

Advantageously, the system according to the present invention makes it possible to verify that the supervisor is in possession of the proper authorizations to access the data kept at the data collection center.

Preferably, the system according to the present invention comprises devices that can be controlled remotely by the supervisor.

Conveniently, the system according to the present invention uses connections for the transmission of data which guarantee security for protection against unauthorized accesses.

Conveniently the system according to the present invention enables a treatment of the data which are managed during the supervision operation which is simple and effective.

Optionally the system according to the present invention can offer tools that make it possible to simply and securely recover and resume the supervision activity from the point where it has been interrupted.

Advantageously the system according to the present invention makes it possible to introduce savings of time and money.

Further characteristics and advantages of the invention will become better apparent from the detailed description that follows, which is given in the form of a non-limiting example with accompanying drawings wherein:

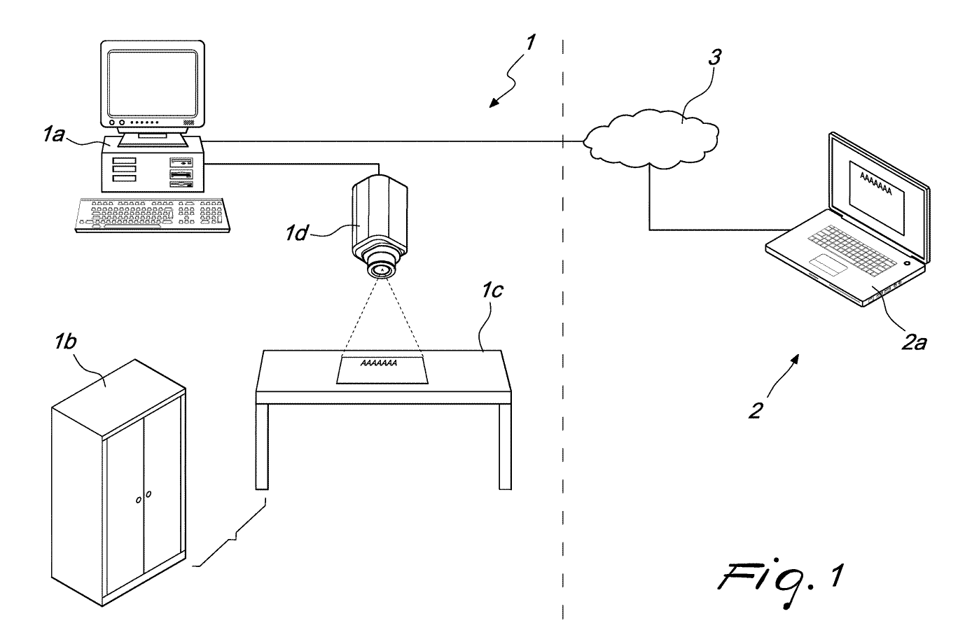

FIG. 1 is a block diagram of a system according to the present invention;

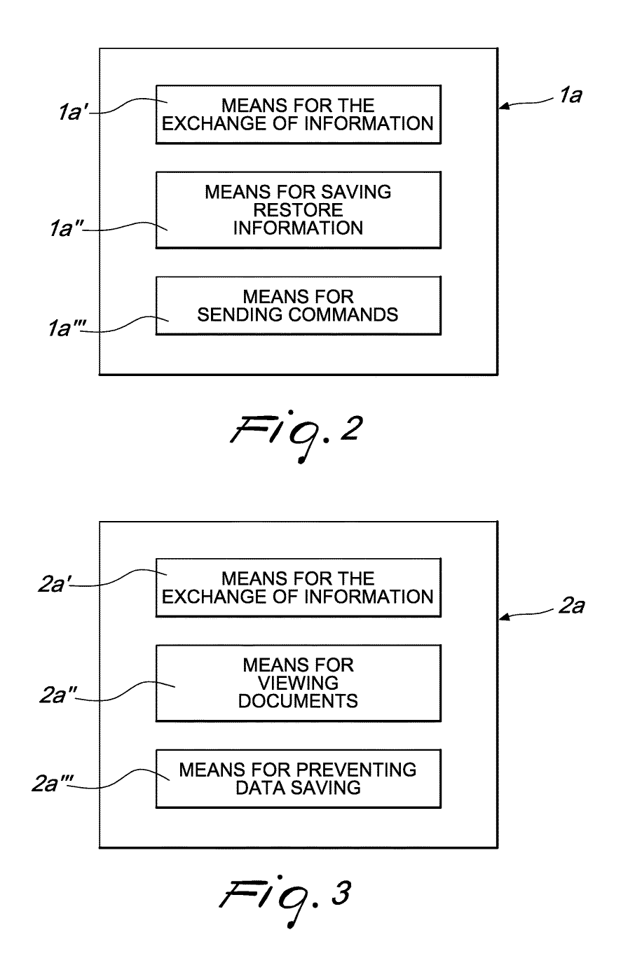

FIG. 2 is a block diagram that shows an aspect of the system according to the present invention in greater detail;

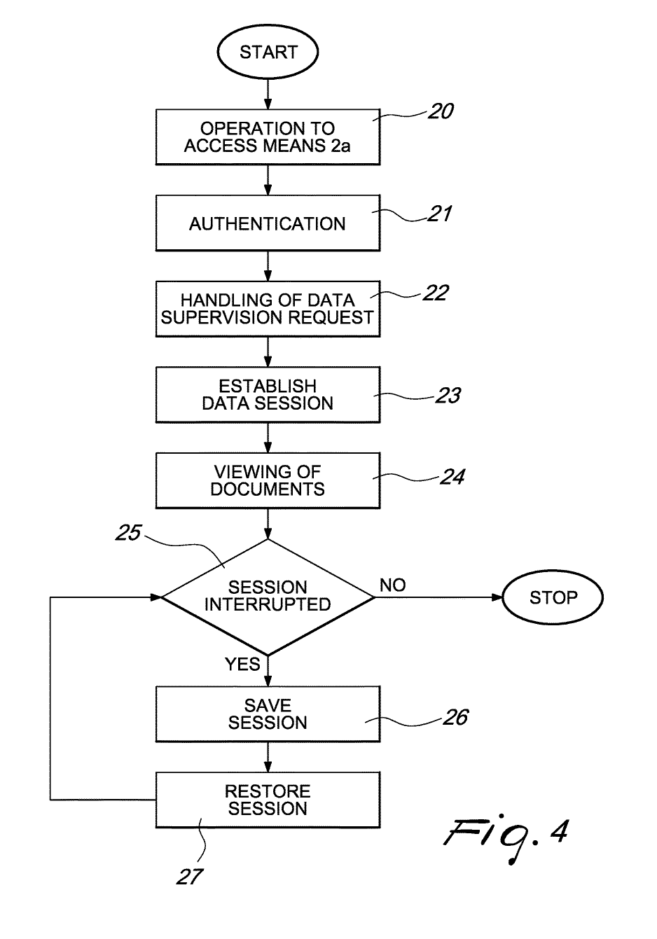

FIG. 3 is a block diagram that shows another aspect of the system according to the present invention in greater detail;

FIG. 4 is a flowchart that shows the operation of the system according to the present invention.

An illustrative architecture of the system that is the subject matter of the present invention is summed up in the block diagram in FIG. 1.

FIG. 1 shows a first station 1 which pertains to an area of a data collection center where the data administrator works and a second station 2 which pertains to an area that is remote with respect to the first area but which is connected thereto by way of a telecommunications network 3.

The station 1 comprises processing means 1a, means of acquisition 1d for capturing an item of information associated with the data on the clinical trial and, optionally, an archive 1b for keeping data on the clinical trial and a work surface 1c.

The processing means 1a are conventional and comprise an electronic computer which is capable of processing information on the basis of instructions provided by the clinical data administrator or by external devices and of executing software modules.

In an embodiment, the processing means 1a comprise a personal computer or an equivalent device with similar capacities of processing and of interfacing with external peripherals connected thereto, such as for example the means of acquisition 1d. In any case, the means 1a, which are inside the data collection center data (for example a hospital or research center), can comprise simpler devices than a personal computer, for example an appliance, or a dedicated device, but in any case connected to the means 1d.

Preferably, the processing means 1a have access to the telecommunications network of the data collection center and, for example through access to the internet, are capable of exchanging information by way of a temporary data session with the processing means 2a of the station 2.

Furthermore, the processing means 1a can comprise software for video conferencing. In another embodiment the processing means comprise means adapted to access a web site or an external server for the management of video calls: in this embodiment, the means 1a are relatively simpler, in that they do not comprise additional software modules for the management of video calls and they make it possible to access remote web-conferencing services. The person skilled in the art will understand that the means 1a can be provided in a different way, for example by way of reconfiguration of the pre-existing hardware architectures, conveniently modified, of the data collection center, for example by way of integration of software modules. The processing means 1a will be described in greater detail with reference to FIG. 2.

The archive 1b is a system in which the sensitive data are kept and in particular a system, such as for example a binder, in which entries, documents, electronic or on paper, produced and acquired by the data administrator during the carrying out of the clinical trial, are cataloged and carefully kept. Typically the data kept in the archive 1b comprise the medical files of the patients who are involved in the trial. The term “medical file” is used to mean the entire set of information about the patient, his/her medical history, for example analyses, X-rays, computerized tomography printouts, laboratory tests. The medical file can be of the paper type but it can also be electronic. The medical file in electronic format for example can comprise scans, for example in Portable Document Format (PDF) format, which are obtained by way of a scanner, or in a proprietary format, organized according to the practices of the hospital. In an embodiment, the archive 1b further comprises storage means adapted to contain, in addition to paper documents, means, such as for example mass storage, which are adapted to store electronic documents. Hereinafter it is assumed, but not exclusively, that the archive data 1b contains preferably medical files. The archive 1b can further be adapted to contain the CRF documents on paper and/or in electronic format. The data administrator retrieves, at the request of the supervisor, the documents kept in the data archive 1b and makes them available to the supervisor on the work surface 1c.

The work surface 1c allows the exhibiting of the documents kept in the archive 1b in order to allow the supervisor to view them. Typically the work surface 1c is in an area that is especially set up for the consultation of such documents by the supervisor and which is protected i.e. to which access is controlled in order to prevent unauthorized access to the exhibited documents. For paper documents, the work surface 1c can thus be a desk, a table or the like, which makes it possible to exhibit the documents. In an embodiment in which the data also comprise electronic documents, the work surface 1c comprises means for exhibiting these data, such as for example electronic whiteboards and screens.

The means of acquisition 1d comprise devices for the acquisition of video flows and stills and particularly for the capture of an item of information associated with the data collected for the clinical trial and shown on the work surface 1c. In the preferred embodiment such means 1d comprise a video camera, optionally movable/motorized or capable of being moved in response to a command of the software type. Furthermore the means of acquisition 1d are provided with means, such as for example zoom, which make it possible to optimally display images of the documents shown on the work surface 1c. Preferably, the means of acquisition 1d are provided with logic and hardware which are such as to be able to receive control commands from the processing means 1a.

The processing means 2a are functionally equivalent to the means 1a and can for example comprise devices such as personal computers, laptops and tablet computers which are provided with a conventional operating system that can be accessed by way of credentials entered in a window for logging in/out and means for the management of a video call, such as for example a microphone, screen and web-conferencing software. The processing means 2a are made available to the supervisor and are preferably arranged in an area that is controlled for example by staff tasked with supervising the work of the supervisor. The processing means 2a are better described with reference to FIG. 3.

The telecommunications network 3 is conventional and can for example comprise an infrastructure adapted to provide access to the internet and capable of placing the first 1 and the second 2 station in communication. Typically the station 1 accesses the network 3 by way of the existing infrastructure of the data collection center, but if it is not possible to use it owing to structural constraints or if its connectivity is limited to the extent that it does not allow for example the setting up of video calls, it is possible to provide the station 1 with an additional modem preferably of the wireless type (Wi-Fi, 3G or 4G) which makes it possible to reach the station 2.

With reference to the block diagram in FIG. 3, some aspects of the processing means 1a will now be explained in greater detail.

The processing means 1a comprise the means 1a′ for the exchange of information, means 1a″ adapted to save restoration information in order to recover a data session, means 1a″′ for sending commands.

The means 1a′ for the exchange of information comprise in particular means for establishing a temporary data session with the corresponding means 2a′ of station 2. Preferably the temporary data session comprises an audiovisual stream, for example provided by way of web-conferencing tools, which comprises the images captured by the means of acquisition 1d.

For example, if the images captured by the means 1d are shown on the screen of the means 1a, the data session can comprise a video call between the data administrator and the supervisor and the sharing of the content of the screen of the means 1a by way of conventional functionalities such as desktop sharing.

Preferably, the means 1a′ are further configured to set up the data session after having verified that the request to display the documents which was generated by the means 2a′ is authorized.

The means 1a″ are adapted to save restoration information in order to recover a data session that was previously set up between the means 1a′ and the means 2a′. Such restoration information comprises for example a session identifier, an item of information that can be associated with the supervisor, a list of the documents viewed by the supervisor, photographs of pages of the documents consulted. Such information is preferably stored securely and in encrypted form (in order to prevent drawbacks owing to loss) on the non-volatile mass storage of the means 1a or on an external mass storage medium which can be connected to the means 1a such as for example a USB flash drive. Preferably this information is encrypted for example by way of asymmetric encryption based on the exchange of public and private keys between the administrator and the supervisor, which would make it possible, among other things, to authenticate the supervisor and verify that he/she has the right to access the restoration information. Preferably, the means 1a or the means 2a comprise optionally-activatable means that make it possible to save this restoration information.

The means 1a′″ are adapted to send commands to the means of acquisition 1d. Such commands make it possible to modify the method with which the capture is carried out of the documents exhibited on the work surface 1c, in order to make the method conform to the requests of the supervisor. Typically, the commands, corresponding to software instructions, are entered by the data administrator and forwarded to the means 1d in response to a request from the supervisor (which may be verbal, transmitted by way of a video call over the network 3, of the type “zoom in on page 1 of document X” or “improve resolution”). Optionally, the means of acquisition 1d can be adapted to process commands that are forwarded directly by the processing means 2a by way of an interaction of the client-server type, optionally passing through the means 1a. In this case also, obviously the supervisor has access only to the documents arranged on the work surface 1c.

With reference to the block diagram in FIG. 3, the second processing means 2a will now be explained in greater detail.

The means 2a comprise means 2a′ for the exchange of information, means 2a″ for the display of documents and means for the prevention of saving 2a″′.

The means 2a′ for the exchange of information are configured to establish a temporary data session with the means 1a′ of station 1 in order to receive data to be displayed by way of the means 2a″. Such session is of the temporary type in that the data received are temporarily stored on the means 2a, for example in a volatile memory unit of the RAM type the content of which is not persistent in that it is lost and rendered unusable following for example an interruption of the power supply current with consequent shutdown of the means 2a. Preferably the temporary data session comprises an audiovisual channel. Preferably the means 2a′ comprise web-based video conferencing software. In particular, the means 2a′ are adapted to set up a video call with the means for exchange of information 1a′. By way of the video call, the supervisor can talk, with the same modes that would be used in a real-life meeting, with the data administrator, for example introducing himself/herself, showing his/her credentials and making requests for documents for examination.

The means 2a″ for displaying documents comprise an intuitive graphical interface which is provided with tools that are adapted to render the display of the documents exhibited on the work surface 1c easily accessible. In particular, the means 2a″ are adapted to display images and video transmissions, received in real time, of the documents exhibited on the work surface 1c while at the same time keeping open the communication channel, preferably of the audio and/or video type, with the data administrator.

The means for preventing saving 2a′″ are configured so as to prevent the persistent/non-volatile saving of information relating to the documents placed on the work surface 1c. In other words the means 2a′″ do not allow the saving of information, i.e. of the video stream and images of the documents, on non-volatile memory media, such as the hard disk of the processing means 2a, mass storage devices such as USB flash drives which can be connected to the processing means 2a, remote servers which can be reached by the processing means 2a by way of cloud computing services and the like, and, in general, the saving on permanent media, such as for example sheets of paper containing printed images by way of a printer connected to the means 2a.

The means 2a″′, in order to prevent the saving of information, are configured to not permit the saving of screenshots, i.e. images, usually of the bitmap type, shown on the screen of the means 2a. Such screenshots would in fact enable the supervisor to illegally obtain copies of the original documents exhibited on the work surface 1c and viewed by him/her by way of the temporary video call data session.

In particular, the means 2a″′ comprise means adapted to detect and inhibit the save functionalities invoked by sequences of keys pressed on the keyboard of the means 2a, which are adapted to save the current contents of the screen and are natively supported by the common operating systems that can be run on the means 2a. These sequences comprise for example, for the Windows operating system, the following keys and key combinations: “Print screen”, “Alt+Print screen”, “Windows key +Print screen”; while for the Apple Macintosh they are: “Cmd +Shift+3”, “Cmd+Shift+4”, optionally combined with the “CTRL” key; for Linux systems using the GNOME and KDE interfaces, it is the “Print screen” key.

The disabling of the functionalities associated with the saving of information can be achieved according to the known art. For example, the means 2a″′ can comprise a so-called software hook, which is adapted to block the pressing of the corresponding keys before the keypress event reaches the procedures of the operating system which would result in the acquisition of the screenshot.

The means 2a′″ for preventing the saving can also comprise means adapted to detect activities that can be ascribed to the saving of images of original documents. In other words, the means 2a′″ for preventing the saving can be capable of monitoring the use of the resources of the means 2a and of reporting uses that depart from the activity of viewing the original documents. Typically in fact the saving of the images entails the use of the hardware resources of the means 2a, such as for example a greater use of volatile memory, greater access to the hard disk, greater use of the processor. On detection of such activities, the means 2a″′ can for example interrupt the data session, notify the data administrator, force the logout of the supervisor from the operating system of the means 2a, generate reports or trace files for forwarding for example to the data administrator or to the superior officer of the supervisor. The means 2a″′ can be provided for example by way of software modules that inhibit certain functionalities that are natively present in the operating systems of the means 2a or by way of hardware modifications or reconfigurations of the means 2a.

With reference to the flowchart in FIG. 4, operation of the system according to the invention will now be explained.

In step 20, the supervisor goes to the station 2 and performs the operation to login to the processing means 2a, by way of for example entering credentials.

In step 21, the supervisor, having obtained access to the means 2a, carries out the step of authentication in order to obtain authorization to view of the data present in the data collection center to which the station 1 pertains, i.e. the supervisor provides a document to show his/her identity. This operation can be concluded for example by way of inserting a username and password in a website of an external body recognized by the data collection center of station 1, which verifies the data, or by way of an exchange of credentials between a client application (present for example on the means 2a or on an external device such as for example the smartphone of the supervisor) and a server which cooperates with or operates on the processing means 1a. Again, it is possible to perform the authentication by way of a device for the detection of biometric data which can be installed on the means 2a or by way of mass storage devices containing an encryption key which can be connected to the means 2a. If the authentication operation is successful, the means 2a generate a request for the supervision of data. The supervision request, suitably formatted, is sent through the telecommunications network 3 to the means 1a.

In step 22, a request for the supervision of data is received on the means 1a. Such request can comprise a request to set up a video call between the means 1a′ and the means 2a′. Preferably the means 1a′ are capable of performing a preliminary evaluation of the request and obtain additional information such as for example the identity of the caller, the reason for the call and optionally useful information for setting up the call such as for example the protocols used and the bandwidth available.

In step 23 the means 1a and 2a are put into communication by way of a video call so as to enable the data administrator and the supervisor to interact.

The video call is preferably provided using remote web-conferencing systems i.e. by way of a site/portal that acts as an interface between the administrator and the supervisor. In such embodiment it is not necessary to install additional software on the means 1a. Access to web-conferencing sites/portals is simple and enables participation in video conferences for persons, such as the data administrator, who might not have sufficient technical skills to enable him/her to use software adapted to provide the video call. Preferably, following a video call request initiated by the supervisor, the means 1a automatically connect to the remote site/portal without further operations by the data administrator. In particular, the supervisor asks the data administrator to exhibit some paper documents for example the medical file of the patient and the CRF document. The data administrator, after having retrieved them from the archive 1b, exhibits them on the work surface 1c.

In step 24, the supervisor views the paper documents thanks to the images sent by the means of acquisition 1d. The supervisor can ask the data administrator to modify the position of the means of acquisition 1d so as to optimize the view of determined parts of the paper document (for example a certain value in the analysis of the blood of a patient). Moreover, during the viewing of the documents, the supervisor remains in communication, for example by way of the video call that was set up previously, with the administrator so as to be able to make further requests such as for example for new documents or a different arrangement thereof on the work surface 1c.

In step 26, optional, following a request to interrupt the session by the supervisor, step 25, the administrator inserts a mass storage device in the means 1a and, by way of the means 1a″, saves the restoration information. Preferably, the restoration information is saved in encrypted form.

In step 27, the supervisor requests the recovery of the data session that was interrupted in step 25. This operation can also be carried out by way of a new video call. The data administrator inserts the mass storage device that was previously used to save the restoration operations in the means 1a. Once the decryption operation is complete, the information for the interrupted session is sent to the processing means 2a.

In practice it has been found that the method and the system described fully achieve the intended aim and objects. In particular, it has been seen that the system thus conceived makes it possible to overcome the qualitative limitations of the known art by placing the clinical researcher tasked with supervision and monitoring in the same conditions in which he/she would be if he/she physically went to the data collection center, and at the same time ensuring that the documents consulted are not moved from that center. By way of the means of acquisition 1d and a video call, the supervisor can guide the data administrator interactively and in real time, by obtaining the viewing of the documents, preferably paper, in every part thereof and with optimal resolution. Furthermore, the system according to the present invention does not provide the supervisor with additional tools with respect to those that would be available if he/she were to consult the documents directly at the data collection center, and which would enable an unauthorized treatment of those data.

Clearly, numerous modifications are evident and can be readily executed by the person skilled in the art without extending beyond the scope of protection of the present invention.

Hence, the scope of protection of the appended claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in Italian Patent Application No. MI2014A001169 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A system for remote monitoring and supervision of data, particularly for activities associated with clinical trials, comprising:
a first station, which pertains to an area in which said data are stored, said first station comprising first processing means and acquisition means for acquiring an item of information associated with said data;
a second station, provided with second processing means, said second station being located in a remote area with respect to the area in which said first station is located;
a telecommunications network, adapted to connect said first processing means to said second processing means;
wherein said second processing means are further configured to display said information acquired by said acquisition means and to prevent the saving of said information on non-volatile memory devices.

12. The system according to claim 11, wherein said first processing means comprises further: means adapted to process a request to display said data, which is generated by said second processing means; means adapted to verify that said request is authorized; and means adapted to allow said display once it has been verified that said request is authorized.

13. The system according to claim 11, wherein said acquisition means comprise a video camera which can be controlled on the basis of a command which is preferably sent by said second processing means.

14. The system according to claim 11, wherein said first processing means and said second processing means are connected by means of an encrypted temporary data session, which preferably comprises a video call.

15. The system according to claim 11, wherein said second processing means comprise means for preventing the saving of said information, comprising:
means for generating alarm signals based on the monitoring of the resources used by said second processing means, said resources comprising the volatile memory and the mass storage of said second processing means; and
means for disabling, on said second processing means, functionalities adapted to save information shown on a screen of said second processing means, said functionalities comprising the saving of screenshots caused by the pressing of a key or keys combination on a keyboard of said second processing means.

16. The system according to claim 11, wherein said first processing means comprise means adapted to save securely the information displayed in said data session on storage means that can be accessed by said first processing means; and means adapted to retrieve the information associated with said data session on the basis of a request generated by said second processing means.

17. The system according to claim 11, further comprising means for authenticating a user who uses said second processing means, said means for authenticating comprising at least one of the following: a biometric detector, an application that can be run on a smartphone, credentials preferably verified by a website, a mass storage device provided with tokens.

18. The system according to claim 11, wherein said data comprise paper documents and said information acquired by said acquisition means comprises images and video streams related to said paper documents.

19. The system according to claim 11, wherein said telecommunications network comprises a connection of the wireless type.

20. A method for remote monitoring and supervision of data, particularly for activities associated with clinical trials, comprising the steps of:
providing a first station which pertains to an area in which said data are stored;
providing said first station with: first processing means; and with means for acquiring an item of information associated with said data;
providing a second station, said second station being located in a remote area with respect to the area of said first station;
providing said second station with second processing means;
providing a telecommunications network adapted to connect said first processing means to said second processing means;
displaying, on the part of said second processing means, said information acquired by said acquisition means ; and
preventing, on the part of said second processing means, the saving of said information on non-volatile memory devices.
